(19) United States
(12) Patent Application Publication
(10) Pub. No.: US 2019/0375521 A1
(43) Pub. Date: Dec. 12, 2019

(54) BOXING DEVICE AND BOXING METHOD

(71) Applicant: KAWASAKI JUKOGYO KABUSHIKI KAISHA, Kobe-shi, Hyogo (JP)

(72) Inventors: Shogo HASEGAWA, Kakogawa-shi (JP); Kazunori HIRATA, Yao-shi (JP); Kentaro AZUMA, Kobe-shi (JP)

(73) Assignee: KAWASAKI JUKOGYO KABUSHIKI KAISHA, Kobe-shi, Hyogo (JP)

(21) Appl. No.: 16/489,182

(22) PCT Filed: Feb. 26, 2018
(86) PCT No.: PCT/JP2018/007010

§ 371 Date: Aug. 27, 2019

(30) Foreign Application Priority Data
Feb. 27, 2017 (JP) 2017-035378

(51) Int. Cl. B65B 5/10; B25J 13/00

(52) U.S. Cl. CPC B65B 5/10; B65B 43/54; B25J 13/00

(57) ABSTRACT

A boxing device includes a second suction unit that applies force to an inner wall surface of a box. The boxing device also includes a boxing device main body part capable of housing an object-to-be-housed in the interior of the box that has been positioned by being moved by the second suction unit applying force to the inner wall surface of the box.

### TECHNICAL FIELD

The present invention relates to a boxing device and a boxing method that perform boxing by housing an object-to-be-housed in an interior of a box that has been positioned.

### BACKGROUND ART

Conventionally, boxing devices that house objects-to-be-housed in an interior of a box have been used. For example, Patent Literature 1 discloses the boxing device that positions a box by using an arm of a robot to house an object-to-be-housed in the interior of the box.

### CITATION LIST

### Patent Literature

PTL 1: JP 2016-179821 A

### SUMMARY OF INVENTION

### Technical Problem

However, the boxing device disclosed in Patent Literature 1 positions the box by pushing an outer wall surface of the box. Therefore, when the outer shape of the box is deformed for some reason, the box may not be accurately positioned.

Considering the above-mentioned circumstances, an object of the present invention is to provide a boxing device and a boxing method with which accurate positioning is possible.

### Solution to Problem

A boxing device of the present invention includes an action portion that applies force to an inner wall surface of a box, and a housing mechanism capable of housing an object-to-be-housed in an interior of the box that has been positioned by being moved by the action portion applying force to the inner wall surface of the box.

The boxing device having the above-mentioned configuration positions the box by moving the box by applying force to the inner wall surface of the box. Therefore, even in a case where an outer part of the box is deformed, the box can be accurately positioned.

Alternatively, a cushioning material may be disposed in the interior of the box, and the action portion may position the box by moving the box by applying force to the wall surface through the cushioning material.

Alternatively, the action portion may position the box by moving the box by applying force to the wall surface through the object-to-be-housed housed in the interior of the box.

Alternatively, the action portion may position the box by moving the box by applying force directly to the wall surface.

Alternatively, the box may be positioned by being moved with the inner wall surface of the box pushed.

Alternatively, the action portion may be a hand portion attached to a robot arm.

A boxing method of the present invention performs boxing using a boxing device including an action portion that applies force to an inner wall surface of a box. The boxing method includes a step of positioning that positions the box by moving the box by applying force to the inner wall surface of the box with the action portion, and a step of housing that houses an object-to-be-housed in the box that has been positioned in the step of positioning.

A boxing method having the above-mentioned configuration positions a box by moving the box by applying force to the inner wall surface of the box in the step of positioning. Therefore, even in the case where the outer part of the box is deformed, the box can be accurately positioned.

### Advantageous Effects of Invention

According to the present invention, an object-to-be-housed can be boxed in a box that has been more accurately positioned in a space in which the object-to-be-housed is to be housed. Therefore, the object-to-be-housed can be accurately housed in a predetermined housing position and quality of the box in which the object-to-be-housed has been housed can be improved.

### BRIEF DESCRIPTION OF DRAWINGS

FIG. 1 is a perspective view of a boxing device according to an embodiment of the present invention.

FIG. 2 is a front view of a boxing device main body part of the boxing device in FIG. 1.

FIG. 3 is a block diagram showing a configuration of a control system of the boxing device in FIG. 1.

FIG. 4 is a flowchart showing a flow of boxing objects-to-be-housed in a box with the boxing device in FIG. 1.

FIG. 5 is a perspective view showing how the boxing device main body part takes out a cardboard plate in the boxing device in FIG. 1.

FIG. 6 is a perspective view showing how the boxing device main body part bends the cardboard plate in the boxing device in FIG. 1.

FIG. 7 is a perspective view showing how the boxing device main body part disposes the cardboard plate in the interior of the box in the boxing device in FIG. 1.

FIG. 8 is a perspective view showing how the boxing device main body part pushes a cushioning material to position the box in the boxing device in FIG. 1.

FIG. 9 is a perspective view showing how the boxing device main body part lifts the objects-to-be-housed that have been placed on a boxing workbench and moves them toward the box in the boxing device in FIG. 1.

FIG. 10 is a perspective view showing how the boxing device main body part disposes the objects-to-be-housed that have been placed on the boxing workbench in the interior of the box in the boxing device in FIG. 1.

FIG. 11 is a perspective view showing, after the boxing device main body part houses the objects-to-be-housed in the interior of the box, how the interior of the box is substantially filled with the objects-to-be-housed in the boxing device in FIG. 1.

FIG. 12 is a perspective view showing how the box whose interior is substantially filled with the objects-to-be-housed is conveyed in the boxing device in FIG. 1.

### DESCRIPTION OF EMBODIMENTS

Hereinafter, a boxing device and a boxing method according to embodiments of the present invention will be described with reference to the accompanying drawings.

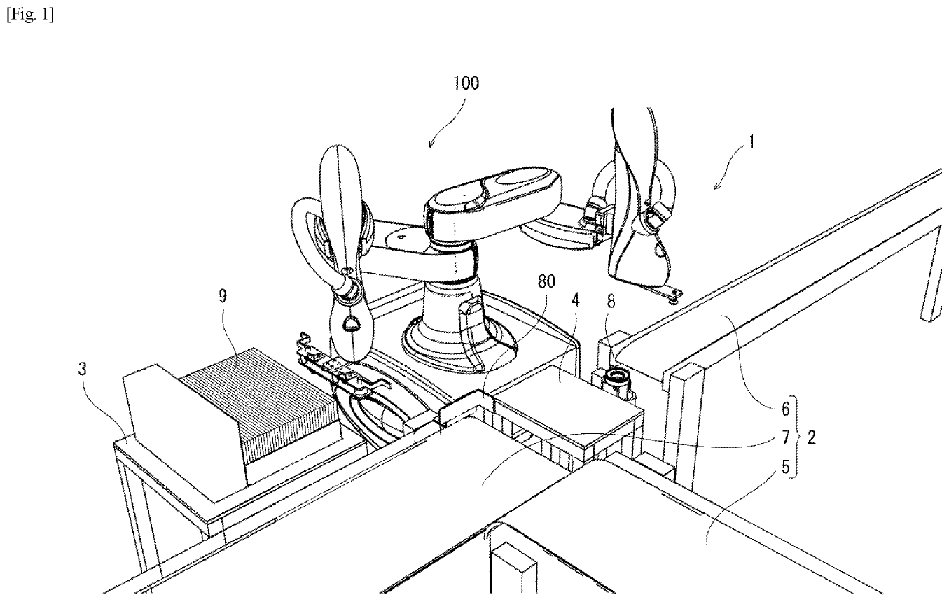

FIG. 1 shows a configuration of a boxing device according to an embodiment of the present invention. As shown in FIG. 1, a boxing device 1 includes a boxing device main body part 100, a pair of conveyor belts 2, a platform 3 on which cardboard members serving as a cushioning material are stacked, and a boxing workbench 4 on which boxing is performed.

The pair of conveyor belts 2 includes a conveyer belt 5 that conveys a box, a conveyor belt 6 that conveys objects-to-be-housed, and a conveyor belt 7 that conveys the box housing the objects-to-be-housed in the interior thereof.

A plurality of cardboard plates 9 is disposed on the platform 3. One cardboard plate is taken out from the plurality of cardboard plates 9 and then is disposed in the interior of the box as a cushioning material 9a. The cushioning material 9a is disposed in a gap between an inner wall surface of the box and the objects-to-be-housed.

In a case where there is a gap between the inner wall surface of the box and the objects-to-be-housed, the objects-to-be-housed may move in the gap in the interior of the box and collide with the inner wall surface during distribution of the box housing the objects-to-be-housed. In such a case, disposing a cushioning material fills the gap between the inner wall surface of the box and the objects-to-be-housed. Accordingly, during distribution of the box, the objects-to-be-housed can be suppressed from moving in the interior of the box, and thus the objects-to-be-housed can be suppressed from colliding with the inner wall surface of the box. As a result, the objects-to-be-housed can be suppressed from being deformed due to collision, and thus the quality of the objects-to-be-housed can be improved.

Between the conveyor belt 6 that conveys objects-to-be-housed and the boxing workbench 4 on which boxing is performed, a label inspection camera 8 that checks whether the objects-to-be-housed are correctly labeled is disposed. In addition, a position regulating member 80 is disposed in a position adjacent to the boxing workbench 4 on the conveyor belt 7 that conveys the box. The position regulating member 80 is formed into an L shape so as to come into contact with a corner portion of the box. The position regulating member 80 can regulate the position of a box 11 by being pressed against the box 11 at a time of positioning the cushioning material 9a and the box 11 described later.

Next, a configuration of the boxing device main body part 100 will be described.

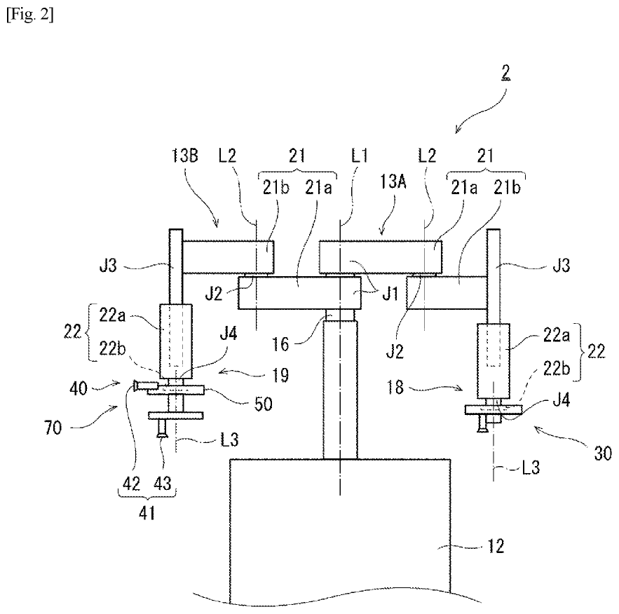

FIG. 2 shows the boxing device main body part 100 of the present embodiment. FIG. 2 is a front view of the boxing device main body part 100. As shown in FIG. 2, the boxing device main body part 100 includes a horizontal articulated double arm robot having a pair of robot arms 13.

The boxing device main body part 100 includes a first robot arm 13A and a second robot arm 13B. A tip end portion of the first robot arm 13A is provided with a first holding portion 18. A tip end portion of the second robot arm 13B is provided with a second holding portion 19. Hereinafter, the first robot arm 13A and the second robot arm 13B are merely referred to as a robot arm 13 when no distinction is made therebetween.

The boxing device main body part 100 includes a control portion 14 and a vacuum generator (not shown).

The control portion 14 is provided inside a support base 12 of the boxing device main body part 100, for example. However, the configuration is not limited to this, and the control portion 14 may be provided inside the robot arm 13 or the like. Alternatively, the control portion 14 may be provided in other empty spaces.

The vacuum generator is, for example, a vacuum pump or CONVUM (registered trademark). Similar to the control portion 14, the vacuum generator is provided inside the support base 12, for example. However, the configuration is not limited to this, and the vacuum generator may be provided in other locations such as inside the robot arm 13. The vacuum generator is connected to a first suction unit 30 and a second suction unit 40 described later through a pipe that is not shown. The pipe is provided with an on-off valve that is not shown, for example. The pipe is opened or closed by the on-off valve. A control device controls the operation of the vacuum generator and opening and closing of the on-off valve described above.

The first robot arm 13A moves the first holding portion 18 within a predetermined operation range. The second robot arm 13B moves the second holding portion 19 within a predetermined operation range. The robot arm 13 is a horizontal articulated robot arm, for example, and includes an arm portion 21 and a wrist portion 22. Moreover, the first robot arm 13A and the second robot arm 13B can operate independently of each other and interrelatedly.

The first holding portion 18 and the second holding portion 19 each are configured to be capable of gripping a hand portion having a specific function.

The boxing device main body part 100 includes the support base 12 and a base shaft 16 extending upward in a vertical direction from the support base 12. The base shaft 16 is attached to the support base 12 so as to be rotationally movable.

The arm portion 21 is attached to the base shaft 16 so as to extend in a horizontal direction. The arm portion 21 is attached so as to be rotatable around the base shaft 16.

The arm portion 21 includes a first link 21a and a second link 21b. The first link 21a and the second link 21b are supported so as to be mutually rotatable along the horizontal direction. The first robot arm 13A and the second robot arm 13B are connected to the base shaft 16 through the arm portion 21.

The arm portion 21 positions the wrist portions 22 attached to the tip end portions of the first robot arm 13A and the second robot arm 13B in an arbitrary position within the operation range.

A base end of the first link 21a is coupled to the base shaft 16 of the support base 12 by a rotary joint J1, and thus the first link 21a is rotatable around a rotary axis L1 that passes through an axis of the base shaft 16. The second link 21b is coupled to the tip end portion of the first link 21a by a rotary joint J2, and thus is rotatable around a rotary axis L2 defined by the tip end portion of the first link 21a.

The wrist portion 22 changes a mechanism linked to an end thereof into an arbitrary posture. The wrist portion 22 includes a raising and lowering portion 22a and a rotatable portion 22b. The raising and lowering portion 22a is coupled to the tip end portion of the second link 21b by a linear motion joint J3, and thus is capable of being raised and lowered with respect to the second link 21b. The rotatable portion 22b is coupled to the bottom end portion of the raising and lowering portion 22a by a rotary joint J4, and thus is rotatable around a rotary axis L3 defined by the bottom end of the raising and lowering portion 22a.

In the present embodiment, the rotary axes L1 to L3 are parallel to each other, and extend in the vertical direction, for example. Moreover, the extending direction of each of the rotary axes L1 to L3 and the raising and lowering direction of the raising and lowering portion 22a are parallel to each other.

The arm 13 is provided with a servomotor for driving (not shown), an encoder (not shown) that detects the rotation angle of the servomotor, and the like so as to correspond to each of the joints J1 to J4. Moreover, the rotary axis L1 of the first robot arm 13A and the rotary axis L1 of the second robot arm 13B are located on the same straight line, and the first link 21a of the first robot arm 13A and the first link 21a of the second robot arm 13B are disposed with a difference in vertical height.

Next, a hand portion capable of being gripped by the first holding portion 18 and the second holding portion 19 will be described. In the present embodiment, the first holding portion 18 grips the first suction unit 30 as a hand portion.

Hereinafter, the first suction unit 30 will be described. The first suction unit 30 is provided with a plurality of suction ports 31. The suction ports 31 protrude downward.

Each of the suction ports 31 of the first suction unit 30 is connected to the vacuum generator through the above-described pipe. Therefore, air can be sucked from the suction ports 31. The first suction unit 30 is configured to suck and hold the object-to-be-housed, which is to be housed in a box, at the tip ends of the suction ports 31 by bringing the object-to-be-housed into contact with the suction ports 31 of the first suction unit 30 during suction of air from the suction ports 31.

The first suction unit 30 is gripped by the first holding portion 18, and thus is configured to be movable within the predetermined operation range through driving of the first robot arm 13A.

Moreover, the second holding portion 19 grips, as a hand portion, a suction bending hand portion 70 in which the second suction unit 40 and a cardboard bending unit 50 are unified and configured.

The second suction unit 40 is provided with a plurality of suction ports 41. The second suction unit 40 includes a suction port 42 protruding from a side surface and a suction port 43 protruding downward from a bottom surface. Each of the suction ports 41 of the second suction unit 40 is connected to the vacuum generator through the above-described pipe, and thus air can be sucked from the suction ports 41. The second suction unit 40 is configured to suck and hold the cardboard plate, which will become a cushioning material later, at the tip end of the suction port 42 protruding from the side surface of the second suction unit 40, by performing suction from the suction port 42. The second suction unit 40 is further configured to suck and hold the object-to-be-housed at the tip end of the suction port 43 protruding downward from the bottom surface, by performing suction from the suction port 43.

Furthermore, stopping the suction from the suction ports 41 of the second suction unit 40 enables the second suction unit 40 to release the suction of the cardboard plate. Furthermore, releasing the suction by the second suction unit 40 in a predetermined position enables the cardboard plate to be disposed in a predetermined position in the box.

Furthermore, driving the cardboard bending unit 50 while the cardboard plate is sucked to the second suction unit 40 enables the cardboard plate to be bent. After the cardboard plate is bent by the cardboard bending unit 50 into a predetermined shape, the cardboard plate functions as a cushioning material.

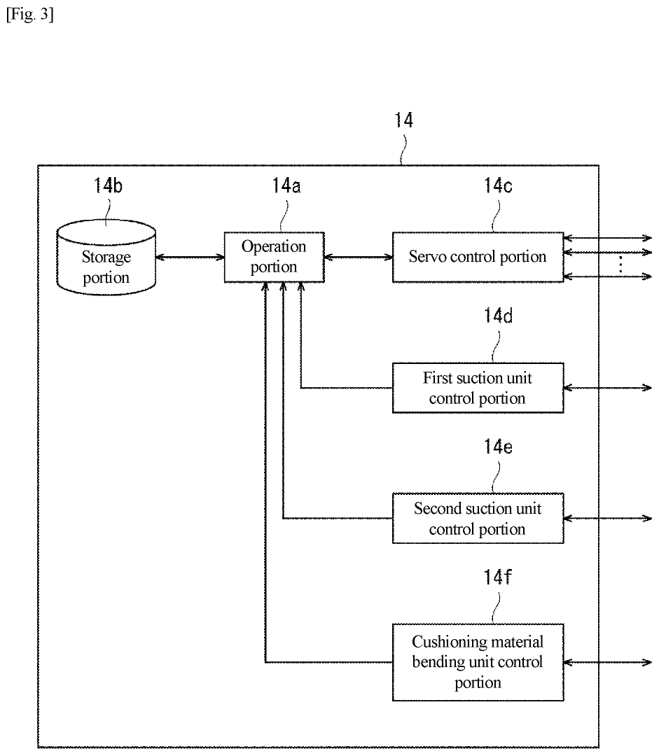

Next, the control portion 14 that controls the operation of the boxing device main body part 100 will be described. FIG. 3 is a block diagram schematically showing an exemplary configuration of a control system of the boxing device main body part 100.

As shown in FIG. 3, the control portion 14 includes an operation portion 14a, a storage portion 14b, a servo control portion 14c, a first suction unit control portion 14d, a second suction unit control portion 14e, and a cardboard bending unit control portion 14f.

The control portion 14 is, for example, a robot controller including a computer such as a microcontroller. Note that the control portion 14 may include a single control portion 14 that performs integrated control, or may include a plurality of control portions 14 that cooperate with each other for dispersion control.

The storage portion 14b stores a basic program as a robot controller and information such as various fixed data. The operation portion 14a reads software such as the basic program stored in the storage portion 14b and executes the software to control various operations of the boxing device main body part 100. That is, the operation portion 14a generates a control command of the boxing device main body part 100, and outputs the control command to the servo control portion 14c, the first suction unit control portion 14d, the second suction unit control portion 14e, and the cardboard bending unit control portion 14f.

The servo control portion 14c is configured to control, based on the control command generated by the operation portion 14a, driving of a servomotor corresponding to each of the joints J1 to J4 of the first robot arm 13A and the second robot arm 13B of the boxing device main body part 100.

Based on the control command generated by the operation portion 14a, the first suction unit control portion 14d controls the vacuum generator and a driving portion to control suction, movement and operation by the first suction unit 30.

Based on the control command generated by the operation portion 14a, the second suction unit control portion 14e controls the vacuum generator and the driving portion to control suction, movement and operation by the second suction unit 40.

Based on the control command generated by the operation portion 14a, the cardboard bending unit control portion 14f controls the vacuum generator and the driving portion to control movement and operation by the cardboard bending unit control portion 14f. The operation by the cardboard bending unit control portion 14f includes bending of a cardboard plate by the cardboard bending unit control portion 14f.

Hereinafter, how the boxing device 1 configured as described above operates to box objects-to-be-housed in the interior of a box will be described.

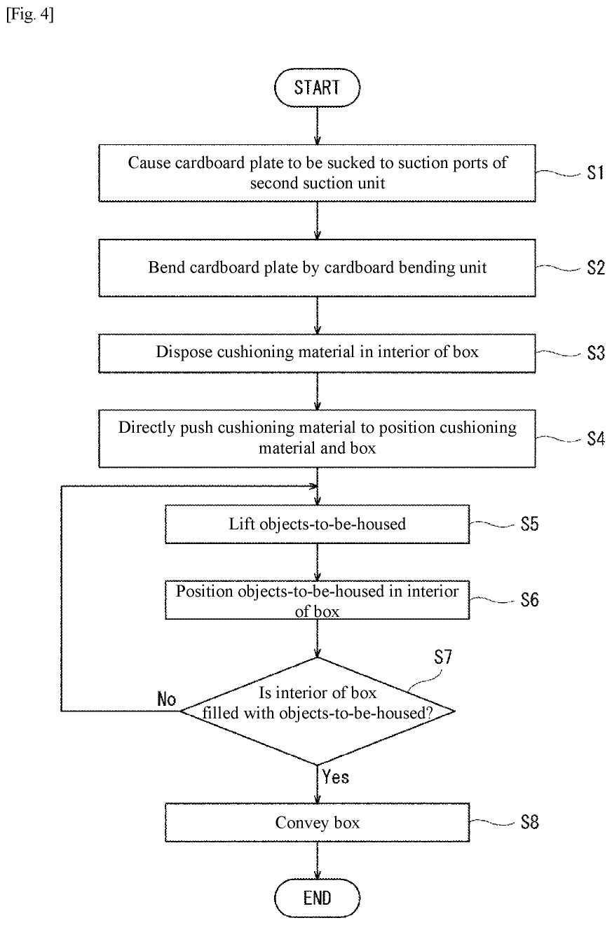

FIG. 4 is a flowchart showing how the boxing device 1 boxes objects-to-be-housed in the interior of a box. Hereinafter, each step of boxing the objects-to-be-housed in the interior of the box will be described with reference to the flowchart of FIG. 4.

First, the suction port 42 protruding from the side surface of the second suction unit 40 sucks a cardboard plate 9 onto the suction port 42 (S1). By so doing, one sheet of the cardboard plate 9 is taken out from a stack of cardboard plates.

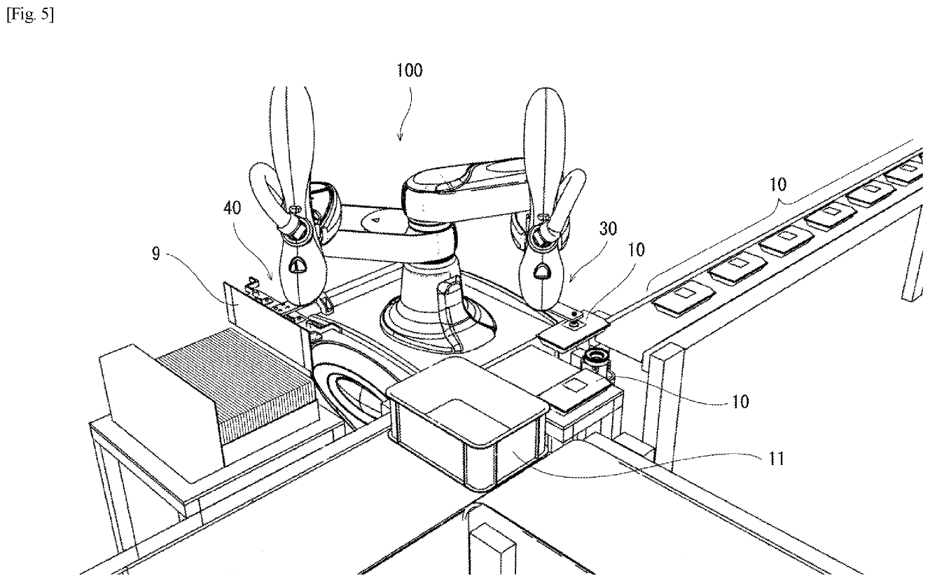

FIG. 5 is a perspective view showing how the suction port 42 protruding from the side surface of the second suction unit 40 sucks the cardboard plate 9 in the boxing device main body part 100.

After one sheet of cardboard plates 9 is taken out, the cardboard bending unit 50 bends the cardboard plate 9 (S2). The cardboard bending unit 50 is driven while the cardboard plate 9 is sucked by the second suction unit 40. As a result, the cardboard plate 9 is bent.

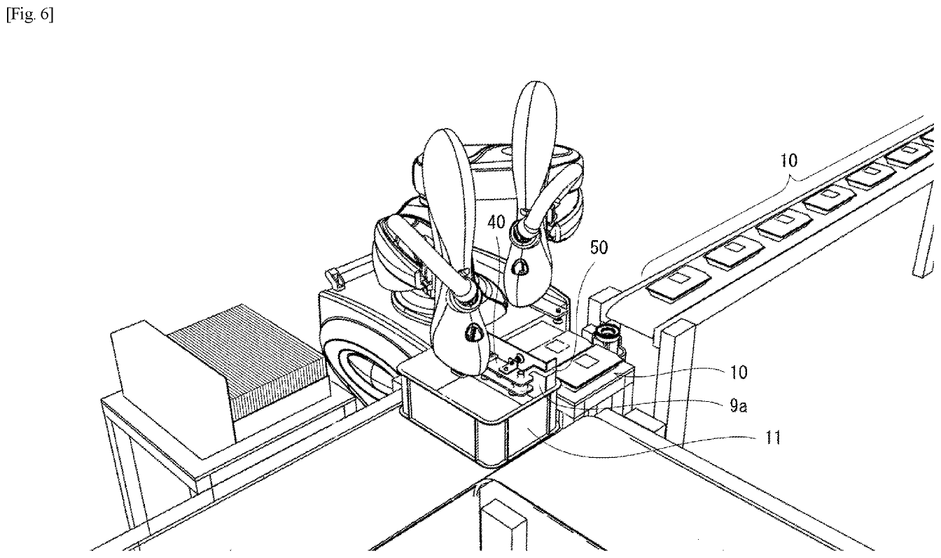

FIG. 6 is a perspective view showing the boxing device main body part 100 when the cardboard plate 9 is bent. Before reaching the state in FIG. 6 from the state in FIG. 5, the suction bending hand portion 70 gripped by the second holding portion 19 rotates around the rotary axis L3, and the orientation of the cardboard plate 9 changes so that a surface opposite to a surface at which the cardboard plate 9 is not sucked faces a side on which objects-to-be-housed are conveyed.

In the state shown in FIG. 6, the cardboard plate 9 is bent at substantially 90 degrees at a position of a predetermined length toward an inner side from an outer end in a width direction. The cardboard plate 9 is bent so that a cross section of the cardboard plate 9 is formed into a substantially U shape. The cardboard plate 9 is bent by the cardboard bending unit 50 into a predetermined shape. Therefore, the cardboard plate 9 functions as the cushioning material 9a in the interior of the box 11.

After the cardboard plate 9 is bent by the cardboard bending unit 50 to be formed into the cushioning material 9a, the cushioning material 9a is disposed in the interior of the box 11 (S3).

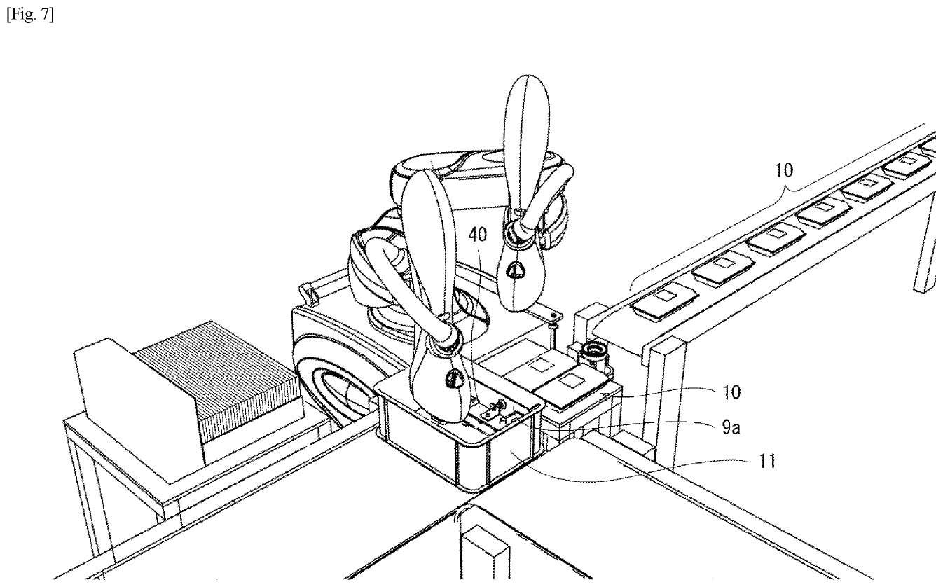

FIG. 7 is a perspective view of the boxing device main body part 100 when the cushioning material 9a is disposed in the interior of the box 11.

The cushioning material 9a is disposed in the interior of the box 11 and then is pushed and moved. The cushioning material 9a keeps being pushed together with the box 11. As a result, the cushioning material 9a and the box 11 are positioned (S4) (step of positioning).

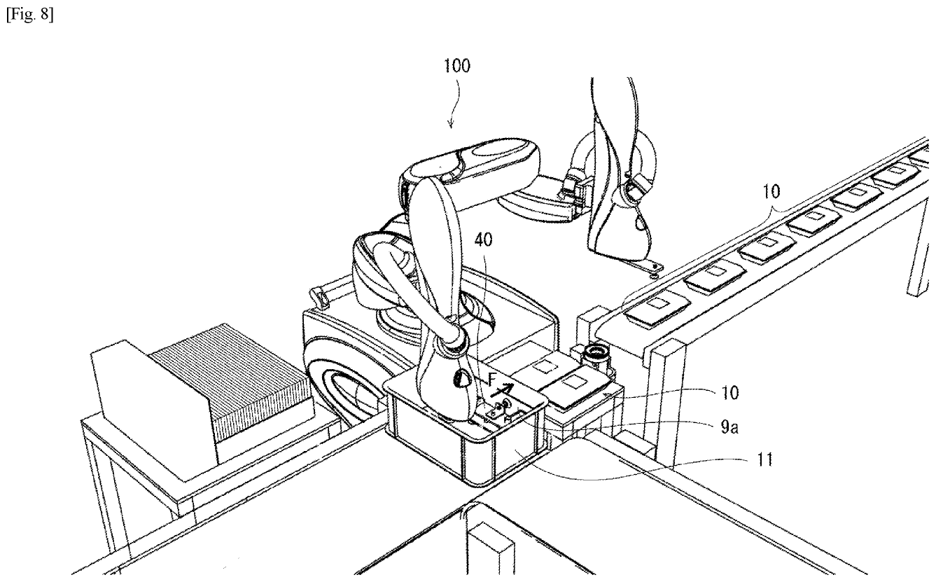

FIG. 8 is a perspective view of the boxing device main body part 100 when the cushioning material 9a is pushed in the interior of the box 11 to move the cushioning material 9a and the box 11, whereby the cushioning material 9a and the box 11 are positioned. In the present embodiment, the inner wall surface of the box 11 is pushed through the cushioning material 9a, whereby the cushioning material 9a and the box 11 are positioned. At this time, the cushioning material 9a and the box 11 are positioned by the second suction unit 40 pushing the box 11 through the cushioning material 9a. Therefore, the second suction unit 40 functions as an action portion that applies force to the inner wall surface of the box 11.

In FIG. 8, an arrow F indicates force applied to the inner wall surface of the box 11 through the cushioning material 9a at a time when the cushioning material 9a and the box 11 are positioned. Since the force is applied in a direction indicated by the arrow F in FIG. 8, the cushioning material 9a and the box 11 are pushed, thereby being positioned.

At a time when the cushioning material 9a and the box 11 are positioned, the position of the box 11 may be regulated to prevent the box 11 from being excessively moved during movement of the box 11. In the present embodiment, the boxing device 1 is provided with the position regulating member 80. Therefore, in a case where the box 11 is about to be excessively moved at a time when the box 11 is positioned, the box 11 comes into contact with the position regulating member 80 and thus the position of the box 11 can be regulated. In the present embodiment, the position of the box 11 can be regulated by the box 11 coming into contact with the position regulating member 80.

In the present embodiment, the position regulating member 80 regulates the position of the box 11 to prevent the box 11 from being excessively moved. However, the position regulating member 80 does not need to be provided. The boxing device 1 does not need to have the position regulating member 80.

After the cushioning material 9a and the box 11 are positioned, the suction of the cushioning material 9a by the second suction unit 40 is released. Moreover, after the suction by the second suction unit 40 is released, the second suction unit 40 moves in a direction away from the cushioning material 9a. After the second suction unit 40 is separated from the cushioning material 9a, positioning of the cushioning material 9a and the box 11 is completed.

The cardboard plate 9 is bent to form the cushioning material 9a, the cushioning material 9a is disposed in the interior of the box 11, and the cushioning material 9a and the box 11 are positioned. Meanwhile, the first suction unit 30 takes out objects-to-be-housed 10 from the conveyor belt 6 and places the objects-to-be-housed 10 on the boxing workbench 4.

In the present embodiment, packed steamed buns are housed as the objects-to-be-housed 10 in the interior of the box 11. Note that in the present invention, an object-to-be-housed subject to boxing is not limited to the embodiment described above. The object-to-be-housed subject to boxing in the interior of a box may be other objects.

When the objects-to-be-housed 10 are placed on the boxing workbench 4, the label inspection camera 8 checks whether each of packages serving as the object-to-be-housed is correctly labeled. If a package is not correctly labeled, the package is excluded without being boxed in the interior of the box 11.

After the cushioning material 9a and the box 11 are positioned, the objects-to-be-housed 10 that have been placed on the boxing workbench 4 concurrently with the positioning thus far are housed in the interior of the box 11. At a time when the objects-to-be-housed 10 are housed in the box 11, the suction port 43 protruding downward from the bottom surface of the second suction unit 40 comes into contact with the objects-to-be-housed 10 that have been placed on the boxing workbench 4 while sucking air. By so doing, the suction port 43 sucks, holds and lifts the objects-to-be-housed 10 (S5).

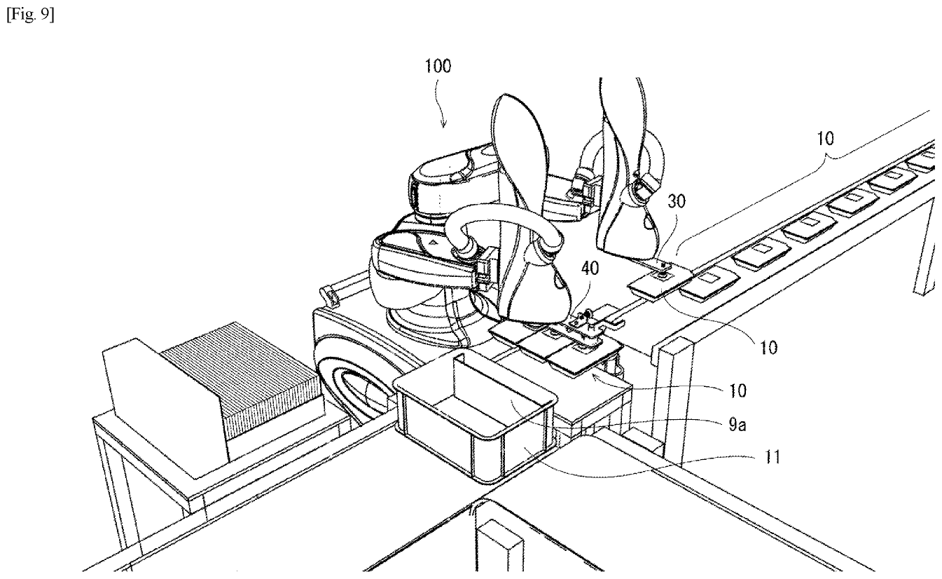

FIG. 9 is a perspective view showing how the second suction unit 40 sucks, holds and lifts the objects-to-be-housed 10 in the boxing device main body part 100.

After the objects-to-be-housed 10 are sucked and lifted by the second suction unit 40, the objects-to-be-housed 10 are moved to a position above the box 11. The second suction unit 40 is moved so as to be lowered from there. Accordingly, the objects-to-be-housed 10 are lowered. As a result, the objects-to-be-housed 10 are housed in the interior of the box 11 (S6). At this time, the position where the box 11 is disposed has been accurately determined. Therefore, the objects-to-be-housed 10 can be disposed with high accuracy in housing positions in the interior of the box 11 that has been accurately positioned. As a result, the objects-to-be-housed 10 can be disposed with high accuracy in positions where the objects-to-be-housed 10 are to be housed without sticking out from the box 11.

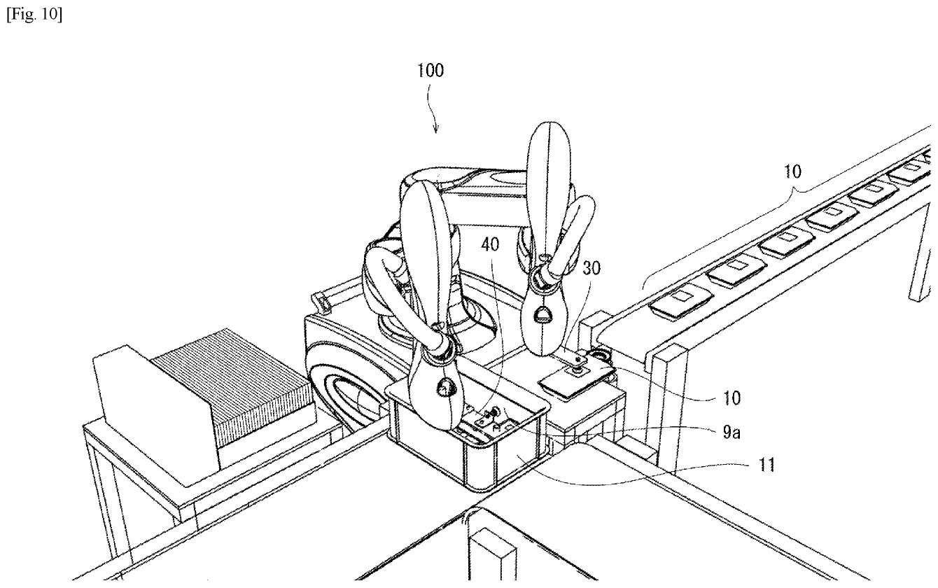

FIG. 10 is a perspective view showing how the second suction unit 40 is lowered and the objects-to-be-housed 10 are located in the interior of the box 11 in the boxing device main body part 100. After the objects-to-be-housed 10 are located in the interior of the box 11, the suction of the objects-to-be-housed 10 by the second suction unit 40 is released and the objects-to-be-housed 10 are disposed in the interior of the box 11. Moreover, the second suction unit 40 is moved in a direction away from the objects-to-be-housed 10 and is retreated from an inner space of the box 11. Housing of the objects-to-be-housed 10 in the interior of the box 11 is repeated until the interior of the box 11 is filled with the objects-to-be-housed 10 (S7) (step of housing).

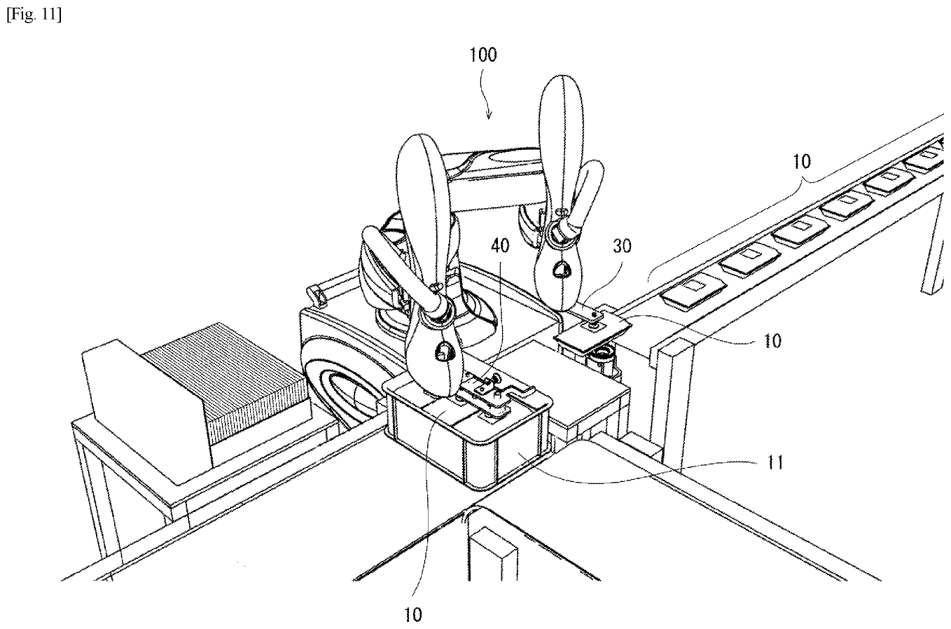

FIG. 11 is a perspective view showing how the interior of the box 11 is substantially filled with the objects-to-be-housed 10 in the boxing device main body part 100 after housing of the objects-to-be-housed 10 in the interior of the box 11 is repeated. After the interior of the box 11 is filled with the objects-to-be-housed 10, housing of the objects-to-be-housed 10 in the box 11 is completed. After the step of housing the objects-to-be-housed 10 in the box 11 is completed, the box 11 is conveyed and moved to the next step (S8).

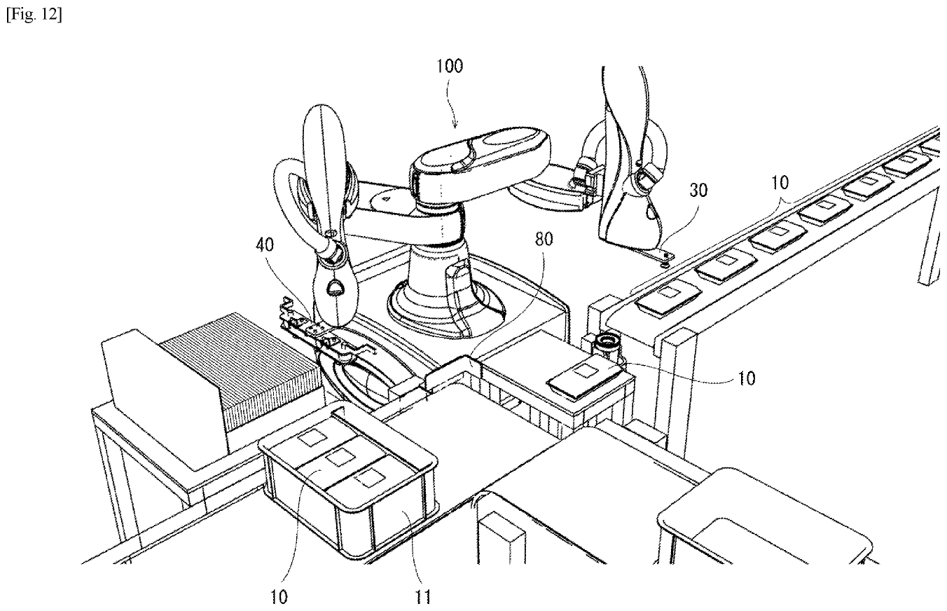

FIG. 12 is a perspective view showing the box 11 being conveyed in the boxing device main body part 100 after the box 11 is substantially filled with the objects-to-be-housed 10. As described above, housing of the objects-to-be-housed 10 in the interior of one box 11 is completed. At this time, the boxing device main body part 100 houses each of the objects-to-be-housed 10 in the interior of the box 11. Therefore, the boxing device main body part 100 functions as a housing mechanism capable of housing the objects-to-be-housed 10 in the interior of the box 11.

In the present embodiment, the box 11 is positioned by force applied to the inner wall surface of the box 11 through the cushioning material 9a (cardboard plate 9). The box 11 is positioned to position the space in the box 11 in which the objects-to-be-housed 10 are to be housed. The box 11 is positioned by force applied to the inner wall surface of the box 11 in which the objects-to-be-housed 10 are to be housed. Therefore, the positioning is performed by force directly applied toward an object to be positioned.

Therefore, the objects-to-be-housed 10 can be housed in the box 11 that has been positioned after the object to be positioned had been further accurately positioned. Accordingly, the objects-to-be-housed 10 can be reliably housed in predetermined positions in the box 11. As a result, the quality of the box 11 in which the objects-to-be-housed 10 are housed can be improved.

In the present embodiment, the cushioning material 9a and the box 11 are positioned by force applied to the inner wall surface of the box 11. Therefore, even in the case where a part of the outer wall surface of the box 11 is deformed, the cushioning material 9a and the box 11 can be accurately positioned regardless of the deformation.

In a case where the box 11 is positioned with the outer wall surface of the box 11 aligned with a target position, if a part of the outer wall surface of the box 11 is deformed, the position of the box 11 is displaced accordingly. As a result, the box 11 may not be accurately positioned.

In the present embodiment, the cushioning material 9a and the box 11 are positioned by force applied to the inner wall surface of the box 11. Therefore, even in the case where a part of the outer wall surface of the box 11 is deformed, the cushioning material 9a and the box 11 can be accurately positioned.

Moreover, in the present embodiment, the boxing device main body part 100 includes a robot. Therefore, when positioning is performed, coordinates of the position of the hand portion attached to the tip end portion of the robot arm 13 can be continuously detected. In the present embodiment, coordinates of the position of the second suction unit 40 can be continuously detected.

Therefore, the cushioning material 9a and the box 11 may be positioned as follows: a difference between the position of the hand portion and target positions of the cushioning material 9a and the box 11 is continuously detected and, when the difference becomes zero, it is determined that the positioning has been finished.

Moreover, in the present embodiment, at a time when the cushioning material 9a is positioned, the cushioning material 9a is pushed and moved. At the same time, the box 11 is moved by being pushed together with the cushioning material 9a. Therefore, the cushioning material 9a and the box 11 can be simultaneously positioned. By so doing, the step of positioning can be simplified and the cushioning material 9a and the box 11 can be positioned at high speed. Since the cushioning material 9a and the box 11 can be positioned at high speed, many of the objects-to-be-housed 10 can be housed and conveyed per unit time. As a result, operation cost of the boxing device 1 can be kept low.

Moreover, since, in the present embodiment, the box 11 is positioned by force applied to the inner wall surface of the box 11 through the cushioning material 9a, the cushioning material 9a can absorb load applied to the box 11 during the positioning. In a case where the box 11 is moved at high speed at a time of positioning the box 11, relatively large load may be applied to the box 11. Even in such a case, in the present embodiment, the inner wall surface of the box 11 is pushed through the cushioning material 9a. Therefore, the cushioning material 9a can function as a cushion to suppress the load applied to the box 11. As a result, deformation of the box 11 due to the load can be suppressed, and thus the quality of the box 11 can be maintained at a high level.

Moreover, in a case where boxing is performed with the cushioning material 9a disposed in the box 11, the boxing conventionally includes a step in which the cushioning material 9a is disposed in the interior of the box 11. In the present embodiment, the box 11 is positioned using the conventionally-performed step in which the cushioning material 9a is disposed in the interior of the box 11. Therefore, the box 11 can be positioned without increasing a new step of positioning the box 11. Therefore, the box 11 can be positioned in a short time without increasing the time required for boxing.

In the embodiment described above, the box 11 is positioned by being moved by force applied to the inner wall surface of the box 11 through the cushioning material 9a, but the present invention is not limited thereto. The box 11 may be positioned by being moved by force applied to the inner wall surface of the box 11 through the object-to-be-housed 10. Alternatively, the box 11 may be positioned by being moved by force applied to the inner wall surface of the box 11 through an object other than the cushioning material 9a and the object-to-be-housed 10. As long as the box 11 is moved by force applied to the inner wall surface of the box 11 at a time of positioning, the box 11 may be positioned by force applied to the inner wall surface of the box 11 through another object.

In such a case, the box 11 is positioned through the object-to-be-housed 10. Therefore, the cushioning material 9a is no longer necessary. Therefore, even in a case where the cushioning material 9a is not used when the object-to-be-housed 10 is housed in the interior of the box 11, the box 11 can be positioned by force applied to the inner wall surface of the box 11.

Moreover, in the embodiment described above, the box 11 is positioned by being moved with the inner wall surface of the box 11 pushed through the cushioning material 9a, but the present invention is not limited thereto. The box may be positioned by being moved by force directly applied to the inner wall surface of the box 11, with the hand portion, attached to the tip end portion of the robot arm in the boxing device main body part 100, brought into contact with the inner wall surface of the box 11. At this time, the box may be positioned by being moved by the hand portion directly pushing the inner wall surface of the box 11. That is, the box 11 may be positioned by being moved by the second suction unit 40, serving as the hand portion attached to the tip end portion of the robot arms 13, directly pushing the inner wall surface of the box 11. As described above, the box 11 may be positioned by being moved by the hand portion of the boxing device main body part 100 directly pushing the inner wall surface of the box 11. That is, the box 11 may be positioned by being moved by the second suction unit 40 directly pushing the inner wall surface of the box 11.

Alternatively, the box 11 may be positioned by force applied to the inner wall surface of the box 11 by means of other methods. For example, the box 11 may be moved in such a manner that a hand portion having a configuration like a human hand operates in a direction of opening the hand to be stretched in the interior of the box 11. Alternatively, the box 11 may be moved in such a manner that a hand portion having another configuration is stretched in the interior of the box 11 and thus force is applied to the inner wall surface of the box 11. If the box 11 is moved by force applied to the inner wall surface of the box 11, another configuration is applicable to move the box 11.

Moreover, in the embodiment described above, the cushioning material 9a is disposed on a side of the object-to-be-housed 10 so as to fill a gap between a side surface of the object-to-be-housed 10 and the inner wall surface of the box 11. The box 11 is positioned while the cushioning material 9a is in contact with the box 11 on the side of the object-to-be-housed 10. However, the present invention is not limited to the embodiment described above. The cushioning material 9a may be disposed in a position other than a side of the object-to-be-housed 10. For example, if a gap is generated between the object-to-be-housed 10 and a ceiling portion of the box 11 when the object-to-be-housed 10 is housed in the interior of the box 11, the cushioning material 9a may be disposed in the gap. In such a case, at a time of positioning, force may be applied to the inner wall surface of the box 11 through the cushioning material 9a that has been disposed in the gap between the object-to-be-housed 10 and the ceiling portion of the box 11. The box 11 may be positioned in the manner described above.

Alternatively, the cushioning material 9a may be disposed between the object-to-be-housed 10 and a bottom surface of the box 11. At a time of positioning, force may be applied to the inner wall surface of the box 11 through the cushioning material 9a disposed between the object-to-be-housed 10 and the bottom surface of the box 11. Alternatively, the cushioning material 9a may be disposed in other positions.

Alternatively, the cushioning material 9a does not need to be disposed in the interior of the box 11. In such a case, the box 11 may be positioned by being moved with the inner wall surface of the box 11 pushed through the object-to-be-housed 10 instead of the cushioning material 9a. In such a case, the box 11 may be positioned by being moved with the inner wall surface of the box 11 pushed through the object-to-be-housed 10 at a time of disposing the object-to-be-housed 10 in the interior of the box 11. Alternatively, as described above, the box 11 may be positioned by the hand portion of the boxing device main body part 100 directly pushing the inner wall surface of the box 11.

### REFERENCE SIGNS LIST

10 object-to-be-housed
11 box
40 second suction unit
100 boxing device main body part

1. A boxing device comprising:
an action portion that applies force to an inner wall surface of a box; and
a housing mechanism capable of housing an object-to-be-housed in an interior of the box that has been positioned by being moved by the action portion applying force to the inner wall surface of the box.

2. The boxing device according to claim 1, wherein
a cushioning material is disposed in the interior of the box, and
the action portion positions the box by moving the box by applying force to the wall surface through the cushioning material.

3. The boxing device according to claim 1, wherein
the action portion positions the box by moving the box by applying force to the wall surface through the object-to-be-housed housed in the interior of the box.

4. The boxing device according to claim 1, wherein
the action portion positions the box by moving the box by applying force directly to the wall surface.

5. The boxing device according to claim 1, wherein
the box is positioned by being moved with the inner wall surface of the box pushed.

6. The boxing device according to claim 1, wherein
the action portion is a hand portion attached to a robot arm.

7. A boxing method for performing boxing using a boxing device including an action portion that applies force to an inner wall surface of a box, the boxing method comprising:
a step of positioning that positions the box by moving the box by applying force to the inner wall surface of the box with the action portion; and
a step of housing that houses an object-to-be-housed in the box that has been positioned in the step of positioning.
